(19) United States
(12) Patent Application Publication
(10) Pub. No.: US 2002/0000055 A1
(43) Pub. Date: Jan. 3, 2002

(54) Magnetic propulsion decorative device

(76) Inventor: Samuel F. Augsburger, Lexington, KY (US)

Correspondence Address: Samuel F. Augsburger, 3805 Plum Lane, Lexington, KY, 40517, US

(21) Appl. No.: 09/771,771

(22) Filed: Jan. 29, 2001

Related U.S. Application Data
(60) Provisional application No. 60/179,517, filed on Feb. 1, 2000.

(51) Int. Cl. G09F 19/00

(52) U.S. Cl. 40/410

(57) ABSTRACT

A decorative device containing fluid and particles of motion which are propelled in motion by a rotating magnet within the fluid container. The rotating magnet within the fluid is propelled in rotation by a magnet external to the fluid container. The rotating magnet external to the fluid container is connected to and rotated by a rotary mechanism.

### BACKGROUND—FIELD OF INVENTION

This invention relates to decorative devices containing fluid and particles of motion.

### BACKGROUND—DESCRIPTION OF PRIOR ART

Decorative devices containing fluid and particles of motion, also commonly referred to as snow globes, have been manufactured and made available to consumers for many years. Such decorative devices are usually shaken or manually rotated to set the particles in the fluid into motion. This particle motion eventually stops as the particles settle to a stop.

Some inventors have attempted to keep such particles in motion by mechanical means. U.S. Pat. No. 5,864,976 to Yang (1999) discloses a complex driving mechanism to perpetuate motion of such particles. This device utilizes a propeller in the fluid driven by a motor located under the fluid chamber. The propeller and motor are connected by a shaft which passes through silicone gaskets. The gaskets prevent fluid loss and rusting of the motor. This driving mechanism is expensive to manufacture and is subject to gasket failure and fluid loss.

U.S. Pat. No. 5,620,353 to Lai (1997) demonstrates using a magnet attached to an ornament within such a decorative device and two magnets attached to a geared mechanism below the fluid chamber. The purpose and function of the device is to revolve and rotate the ornament. The device does not propel the fluid and or particles of motion within the fluid chamber.

U.S. Pat. No. 5,666,750 to Segan et al. (1997) uses an elaborate mechanical means to simulate snowfall. The snow is circulated from the bottom of the device to the top by a series of blades attached to a rotating inner ring. This inner ring is rotated by a geared mechanism. This device is expensive to manufacture and does not use magnets or magnetic fields to propel the fluid within the device.

U.S. Pat. No. 5,313,727 to Murray Jr. (1994) also propels particles in fluid by means of a rotational wind-up device attached to a pumping chamber. The fluid inside the device must be kept from leaking by use of gaskets. This invention is expensive to manufacture and is subject to gasket failure and fluid loss.

### SUMMARY

The present invention utilizes magnets, magnetic fields, and a rotary device to propel particles in the fluid contained by a decorative device.

### OBJECTS AND ADVANTAGES

Accordingly, several objects and advantages of the present invention are:

(a) to propel such particles without potential fluid leakage and rusting of parts.

(b) to simplify the manufacturing process.

(c) to minimize cost of manufacturing.

(d) to provide consumers with an easy to use and less expensive decorative device.

### DRAWING FIGURES

FIG. 1 is a front plan view of the decorative device of the present invention.

FIG. 2 is a side plan view of the decorative device of the present invention.

FIG. 3 is a top plan view of the decorative device of the present invention.

The invention possesses other objects and advantages especially as concerns particular characteristics and features thereof which will become apparent as the specification continues.

Reference Numerals In Drawings

10 container
12 fluid and particles
14 base
16 container sleeve
18 floor
20 ornament
22 internal magnet
24 external magnet
26 rotary shaft
28 rotary mechanism
30 mount
32 rotational plane

### DESCRIPTION—PREFERRED EMBODIMENT

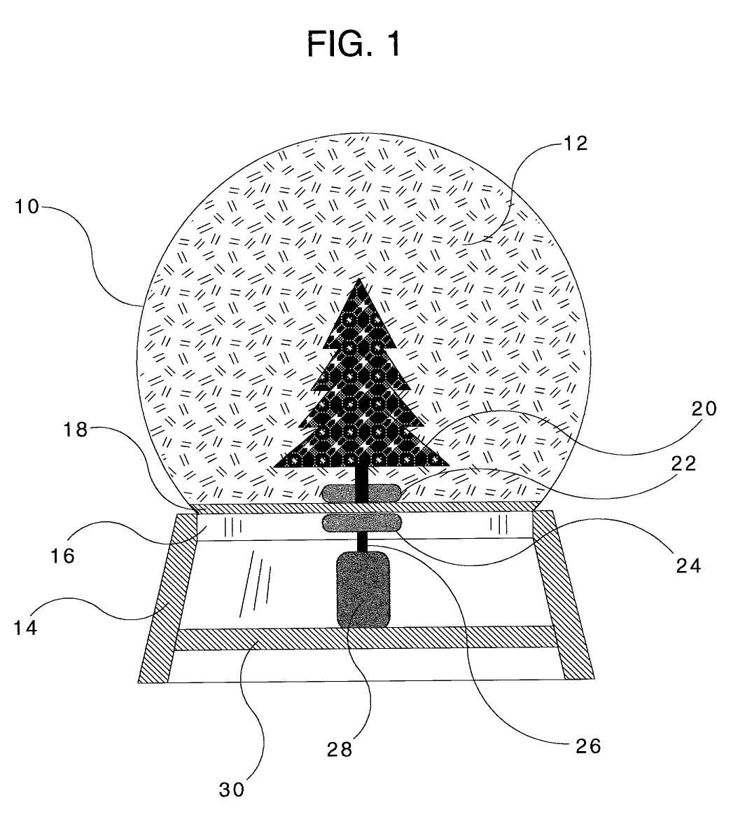

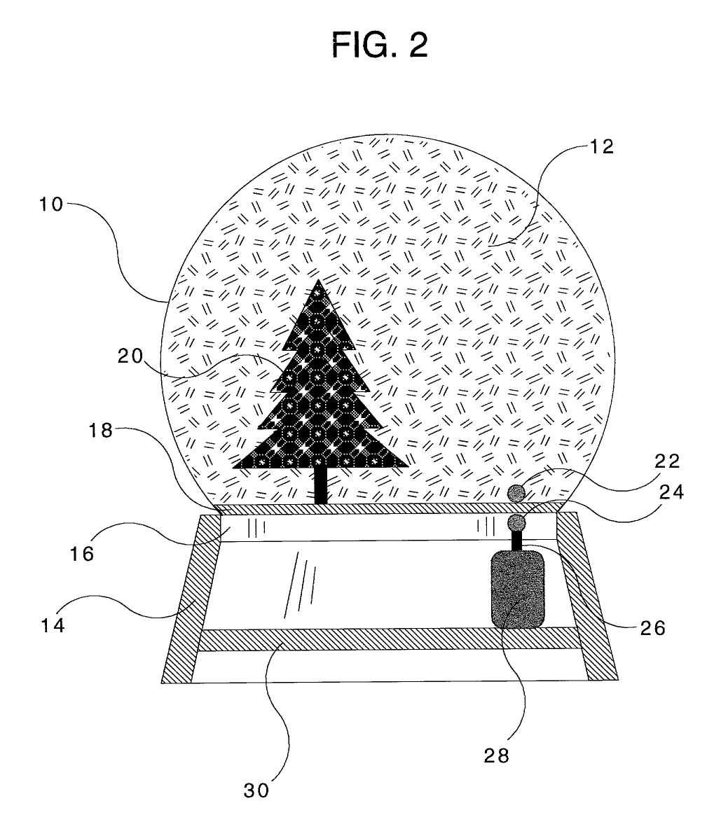

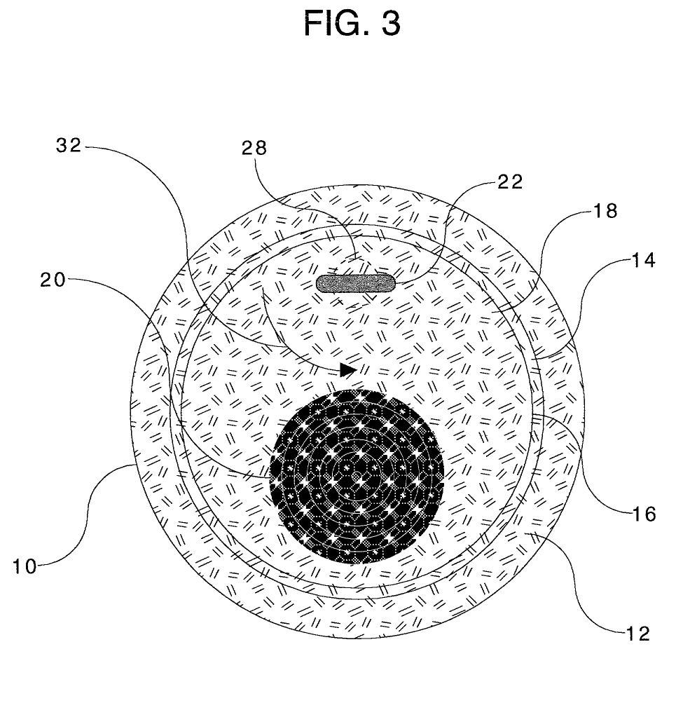

A preferred embodiment of the decorative device of the present invention is illustrated in FIG. 1 (front view), FIG. 2 (side view), and FIG. 3 (top view). A transparent fluid container 10 contains fluid and particles 12 of motion, such as glitter or artificial snow, and an internal magnet 22. The internal magnet 22 may have varied shapes. The internal magnet 22 may be either a man-made magnet or a natural magnet. The internal magnet 22 needs to exhibit rotational resistance to the fluid in order to stir the fluid into motion. The internal magnet 22 may by cylindrical, rectangular, fin-like, or propeller-like. The internal magnet 22 may also have a non-fluid-resistant shape if it is attached to an object which exhibits rotational resistance to the fluid.

The contents of the fluid container 10 are kept from escaping by a fluid proof floor 18 which is tightly sealed to the container at the fluid container sleeve 16. Attached to the floor 18 and internal to the container 10 is an ornament 20 or ornaments.

The shape of the container 10 and the type of ornament 20 are not crucial to the decorative device of the present invention and are not specified herein.

The container sleeve 16 is attached to a base 14. Internal to the base 14 is a rotary mechanism 28. The rotary mechanism 28 is attached to a mount 30 within the base 14. The rotary mechanism 28 may be a electrical or mechanical source of rotation. Out of the rotary mechanism 28 protrudes a rotary shaft 26. Attached to the rotary shaft 26 is an external magnet 24. This external magnet 24 may be a man-made magnet, a natural magnet, or an electromagnet.

The orientation of the external magnet 24 is crucial. The north and south poles of the external magnet 24 must be in a plane parallel to the floor 18 of the container 10. The orientation of the external magnet 24 is illustrated in FIG. 1 and FIG. 2. and the rotational plane 32 of the external magnet 24 and the internal magnet 22 is illustrated in FIG. 3.

Operation

The manner of operating the decorative device of the present invention is to start the rotary mechanism 28. As the rotary mechanism 28 rotates so will the external magnet 24. As the external magnet 24 rotates, a rotating magnetic field is generated. This rotating magnetic field, which penetrates the floor 18, causes the internal magnet 22 to rotate. The rotation of the internal magnet 22 stirs the fluid. The result is a propulsion of fluid and particles 12 with in the decorative device of the present invention.

Conclusion, Ramifications, and Scope

Accordingly, the reader will see that the decorative device of the present invention provides propulsion of fluid and particles within the decorative device. In addition it provides for easy manufacturing of such a decorative device since it does not require elaborate mechanical devices, gaskets and/or other sealing means to keep the fluid from leaking out of the decorative device during operation.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

I claim:

1. A decorative device comprising:
a. a transparent container intended to contain fluid and particles.
b. a free moving internal magnet, be it natural or man-made, internal to said container, with or without an attachment or attachments applied to said magnet.
c. a sealed floor, wall, or area which keeps the said fluid, particles, and magnet internal to said container.
d. a base or stand by which said container is held.
e. a rotary mechanism, be it electrical or mechanical, housed external to said container and held stationary by attachment to said base or stand.
f. a magnet, be it natural, man-made, or electromagnetic, attached to said rotary mechanism in an orientation such that the north and south poles of said magnet are in a plane parallel to the intended plane of rotation of said internal magnet and perpendicular to a rotating shaft protruding from said rotary mechanism.
